(19) United States
(12) Patent Application Publication
(10) Pub. No.: US 2016/0157975 A1
(43) Pub. Date: Jun. 9, 2016

(54) IMPLANT DELIVERY SYSTEM

(71) Applicant: TITAN DENTAL IMPLANT SYSTEMS, LLC, San Antonio, TX (US)

(72) Inventors: H. Mark Estrada, JR., Lakeway, TX (US); Michael John Crescenzo, San Antonio, TX (US); Michael Justin Coke, San Antonio, TX (US)

(73) Assignee: TITAN DENTAL IMPLANT SYSTEMS, LLC, San Antonio, TX (US)

(21) Appl. No.: 14/563,813

(22) Filed: Dec. 8, 2014

(51) Int. Cl. A61C 19/02; A61C 8/00

(52) U.S. Cl. CPC A61C 19/02; A61C 8/0001; A61C 8/005; A61C 8/008; A61C 8/0089

(57) ABSTRACT

Provided is a unit dose dental implant system for oral surgery that includes 1) an implant component, or simply “implant”; 2) an prosthetic abutment component, or simply “abutment”; 3) a healing abutment cap; 4) a locking screw; and 5) a plurality of tools. The implant and abutment are typically deployed in two stages. A first stage involves the surgical placement of the implant into the jaw of a patient. A second stage is a restorative procedure utilizing the abutment. Staging is used to allow patient healing and to allow boney growth to develop on the implant prior to the restorative procedure. The implant, abutment and the tools necessary for the procedures are provide in a sterile condition in a multi-stage container. The implant and the corresponding tools are provided in a first container and the abutment and corresponding tools are provided in a second container.

### FIELD OF THE DISCLOSURE

The claimed subject matter relates generally to a “unit dose” surgical implant system and, more specifically, to a two-stage, multi-section oral surgical kit.

### BACKGROUND

Current dental implant placement procedures are designed to replace the endosseous root of a tooth with a metallic post onto which an artificial tooth is affixed. This procedure is typically performed in two stages, the first stage being the surgical placement of an implant component and the second stage being the attachment of a prosthetic abutment component onto the implant component. Typically, the procedure is performed in two stages to allow patient healing and enable bone structure to grow, also known as “osseointegate,” into and around the implant component, also known as the “anchor.”

In addition, the tools and implant components are not sold in a “unit dose” configuration. In other words, implant components are sold in packages of components containing multiple sizes and the specific size for a particular patient is selected from among the multiple components. Further, the specific tools needed for the procedure are sold in sets of tools, in which some of the tools might not be relevant to a particular procedure.

### SUMMARY

Provided is a dental implant system for oral procedures for, but not limited to, reconstruction, implantation and diagnostics. One embodiment includes four (4) component parts in a variety of diameters and lengths: 1) an implant component, or simply “implant”; 2) an prosthetic abutment component, or simply “abutment”; 3) a healing abutment cap; and 4) a locking screw; and 5) a plurality of tools. In one embodiment components are manufactured from a titanium alloy.

The implant and abutment are typically deployed in two stages. A first stage involves the surgical placement of the implant into the jaw of a patient. A second stage is a restorative procedure utilizing the abutment. Staging is used to allow patient healing and to allow boney growth to develop on the implant prior to the restorative procedure. Provided are the implant, abutment and the tools necessary for the procedures in a multi-stage container. The implant and the corresponding tools are provided in a first container and the abutment and corresponding tools are provided in a second container.

The claimed subject matter packages the implant and abutment in separate individually sterile compartments, each with the corresponding drilling and placement tools necessary for implementation. This disclosed subject matter provides unique advantages over traditional systems, including:
Eliminating the need to sterilize surgical and restorative kits after each surgery for reuse;
Eliminating potential for cross contamination;
Mitigating improper sterilization techniques;
Presenting new instruments unique to every new patient;
Eliminating lost and damaged instruments and need to inventory the instruments; and
Minimizing surgical procedure “turnaround” time.

Although described with respect to “dental” implant system, the claimed subject matter is equally applicable to other types of surgical implant procedures such as, but not limited to, other oral procedures. It should be noted that, although the Specification is described with respect to “dental” procedures, the term “oral” procedures is also applicable and may in fact be a more general term for the disclosed technology.

One feature of the disclosed technology is the fact that the tools and components are provided in a “unit dose” configuration unlike currently available products. As explained above, implant components are currently sold in packages of components containing multiple sizes and the specific size for a particular patient is selected from among the multiple components. Further, the specific tools needed for the procedure are sold in sets of tools, in which some of the tools might not be relevant to a particular procedure. The claimed subject matter provides a surgical kit and a restorative kit that are customized for a specific patient. In this manner, implementation of the dental/oral procedures is simplified for the dental practitioner.

This summary is not intended as a comprehensive description of the surgical placement and restorative procedures involving the claimed subject matter but, rather, is intended to provide a brief overview of some of the clinical functionality associated therewith. Other systems, methods, functionality, features and advantages of the claimed subject matter will be or will become apparent to one with skill in the art upon examination of the following figures and detailed description. It should be understood the claimed subject matter should only be used by personnel who are properly trained and in possession of a dental practitioner's license and appropriate state approval to practice oral surgical procedures.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is an illustration a tray included with a two-stage dental implant delivery system (DIDS) configured in accordance with the claimed subject matter.

FIG. 2 is an illustration a two-stage dental implant delivery system (DIDS) configured in accordance with the claimed subject matter.

FIG. 3 is an illustration of a surgical kit of the DIDS introduced above in conjunction with FIG. 2 in greater detail.

FIG. 4 is an illustration of a restorative kit of the DIDS introduced above in conjunction with FIG. 2 in greater detail.

FIG. 5 is a flowchart of surgical procedure that employs the surgical kit of FIGS. 2 and 3.

FIG. 6 is a flowchart of restoration procedure that employs the restorative kit of FIGS. 2 and 4.

### DETAILED DESCRIPTION OF THE FIGURES

Although described with particular reference to a dental implant system, the claimed subject matter can be implemented in any surgical implant system in which the described advantages are desirable.

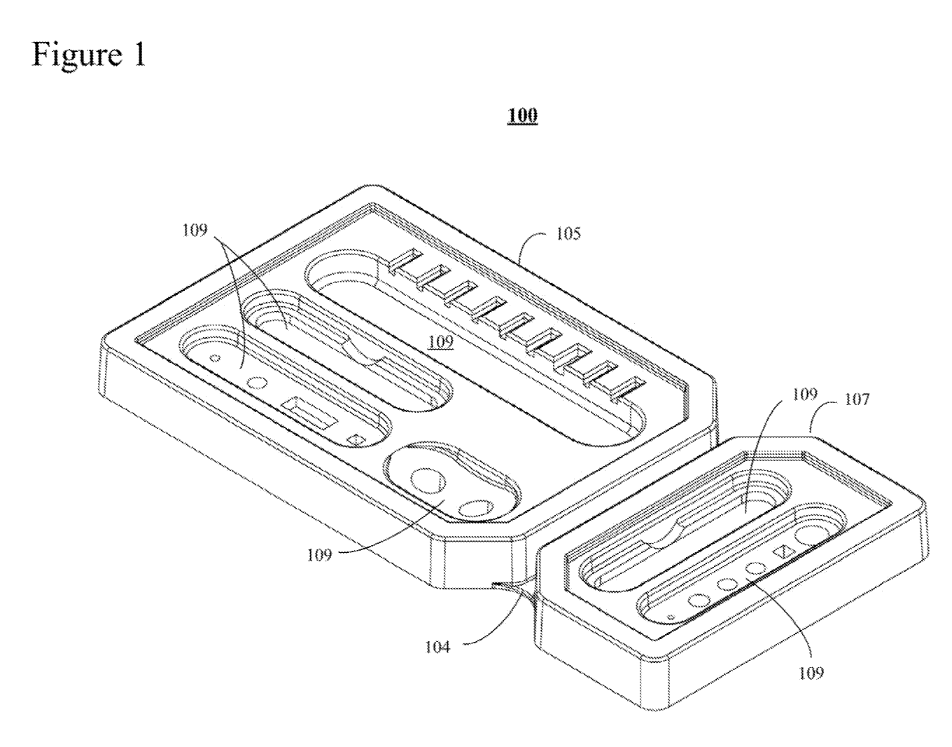

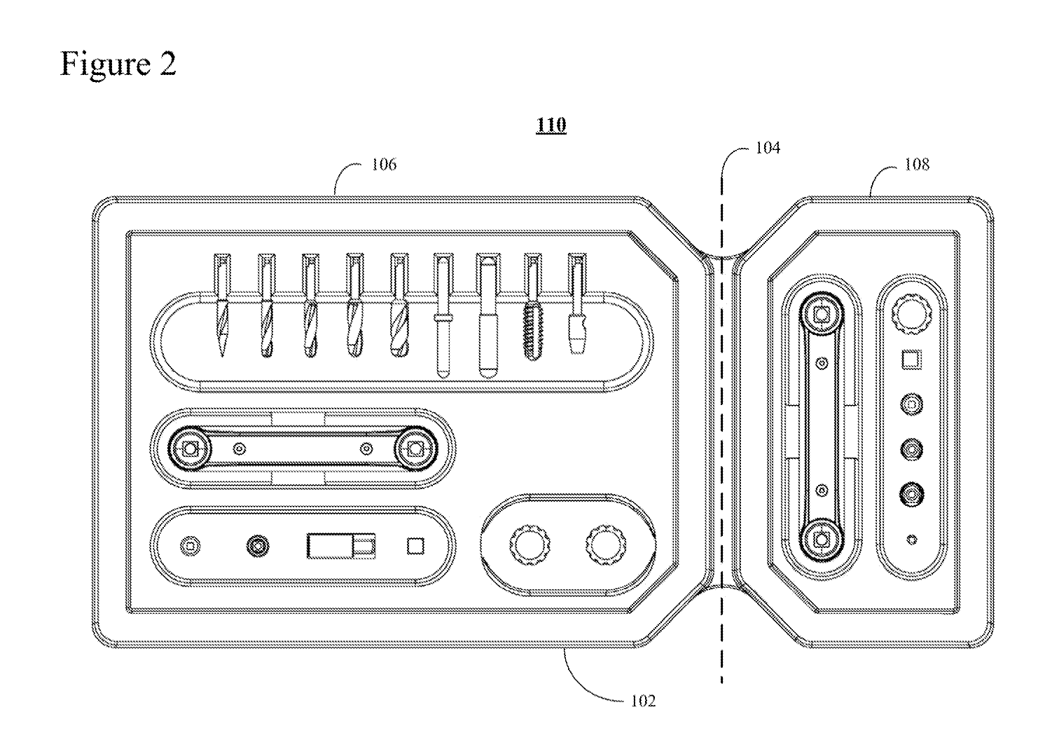

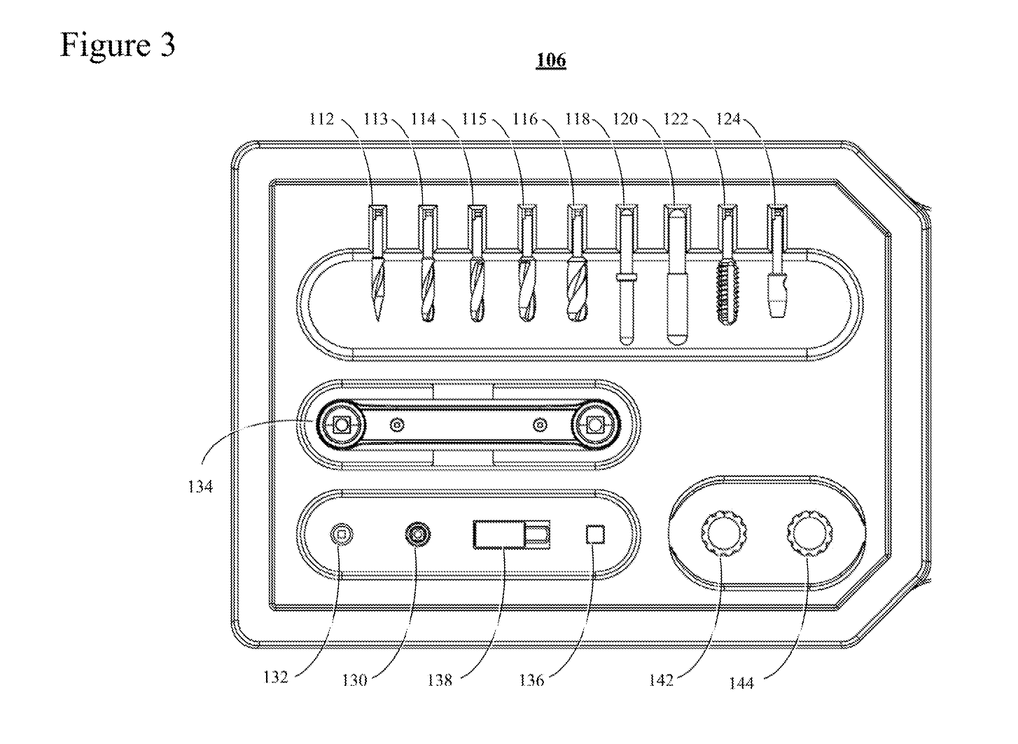

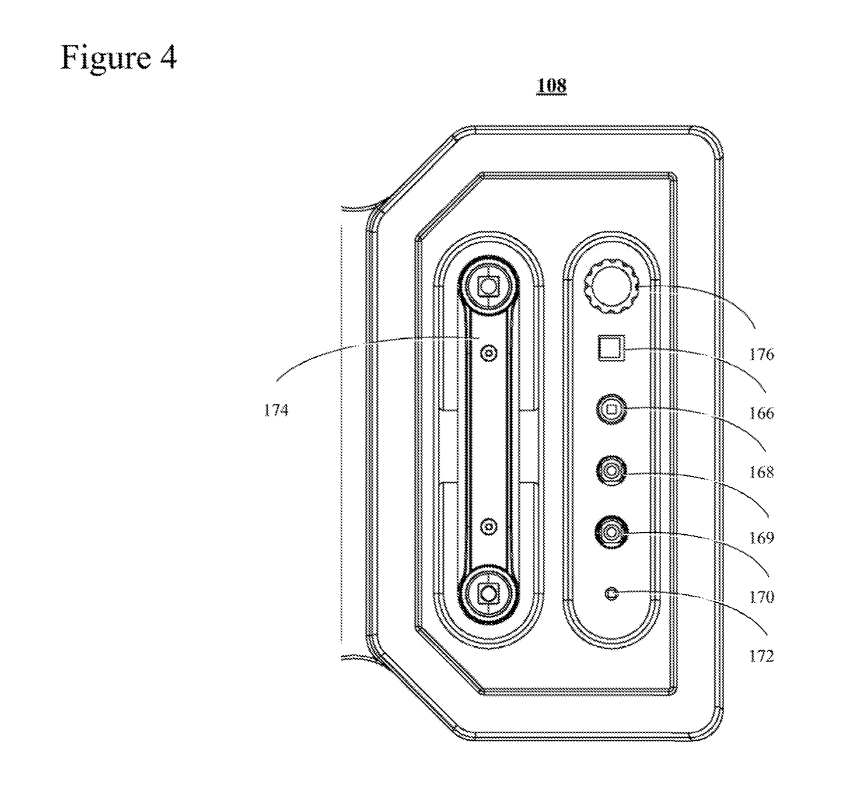

FIG. 1 is an illustration an empty tray 100 included with a two-stage dental implant delivery system (DIDS) (see FIGS. 2-4) configured in accordance with the claimed subject matter. A tray 100 is divided by a breakable hinge 104 and includes a first stage portion 105 for holding tools and devices, or a “surgical kit” 106 (see FIG. 3), on one side of hinge 104 and a second stage portion 107 for holding tools and devices, or “restorative kit” 108 (see FIG. 4), on the other side of hinge 104. In other words, tray 100 includes both the container for first stage portion 105 and second stage portion 107. Hinge 104 enables surgical kit 106 and restorative kit 108 to be separated from each other so that each can be deployed at the appropriate time during a patient's treatment. Although illustrated with a breakable hinge, surgical kit 106 and restorative kit 108 could be coupled many different ways, such as simply be packaged in a common package or even provided separately. Tray 100 includes molded indentations 109 configured to hold the various tools and devices of kits 106 and 108.

FIG. 2 is an illustration a two-stage dental implant delivery system (DIDS) 110 configured in accordance with the claimed subject matter, including the various tools and devices of kits 106 and 108 installed in indentations 109 (FIG. 1) or container 100 (FIG. 1). The actual tools and devices of surgical kit 106 are illustrated, labeled and described below in conjunction with FIG. 3. The actual tools and devices of restorative kit 108 are illustrated, labeled and described below in conjunction with FIG. 4.

As shown above in conjunction with FIG. 1, tray 100 is divided by breakable hinge 104 and includes surgical kit 106 on one side of hinge 104 and restorative kit 108 on the other side of hinge 104. Hinge 104 enables surgical kit 106 and restorative kit 108 to be separated from each other so that each can be deployed at the appropriate time during a patient's treatment. Surgical kit 106 is deployed first and, after a period of time to allow boney growth, or “osseous integration,” on an implant 130 (see FIG. 2), restorative kit 108 is deployed.

FIG. 3 is an illustration of surgical kit 106 of DIDS 110 introduced above in conjunction with FIG. 2 in greater detail. A starter, or “pilot,” drill bit 112 is an initial drill bit used to begin surgical cutting, or “osteotomy,” into a patient's bone. A series of twist drill bits, or simply “drill bits,” 113-116 enable a systematic step progression and proper implementation of the osteotomy to avoid “overheating” or “necrosis” of the patient's bone. Therefore, each drill bit 113-116 is slightly greater in diameter than the previous one.

A plurality of parallel pins 118 and 120 enable the orientation of the osteotomy to be verified. In addition, a drill tap 122 enables the hole created by drill bits 112-116 to be threaded and prepared to accept a threaded implant fixture 130. An extender 124 is provided to enable deeper osteotomy preparations in anterior or restricted spaces within the patient's oral cavity.

Once a proper osteotomy has been completed, implant fixture 130 is installed in the site prepared with drill bits 112-116. Implant fixture 130 is then threaded into the cavity site with a torque wrench 134 to ensure that the proper force is applied to and that implant fixture 130 is properly seated. A healing cap 132 is then affixed to the top of implant fixture 130. Healing cap 132 protects and seals the internal aspect of implant fixture 130 during the osseous integration process between the surgical application of implant fixture 130 and the installation of a prosthetic abutment (see 166, FIG. 4) in conjunction with restorative kit 108 (FIG. 2; see FIG. 4).

An implant driver 136 enables implant fixture 130 to be placed into an appropriate position in a patient's bone. A drive extender 138, used in conjunction with implant driver 136, enables a dental practitioner to place implant fixture 130 in the anterior region or more restricted areas in the mouth. A micro thumb driver 142 and a standard thumb driver 144 are employed to place and remove drill bits 112-116 and healing cap 132.

Each of components 112-116, 118, 120, 122, 124, 130, 132, 134, 136, 138, 142 and 144 is sterilized and fitted into molded indentations 109 of implant kit 106. The upper surface of implant kit 106 is covered with a material (not shown) that enables components 112-116, 118, 120, 122, 124, 130, 132, 134, 136, 138, 142 and 144 to remain sterile until surgical application. New instruments are used for each patient, which prevents lost or damaged instruments and minimizes turnaround time. In this manner, the claimed subject matter eliminates the need to sterilize implant kit 106 either before or after surgery, mitigating improper sterilization techniques and the potential of cross contamination between patients.

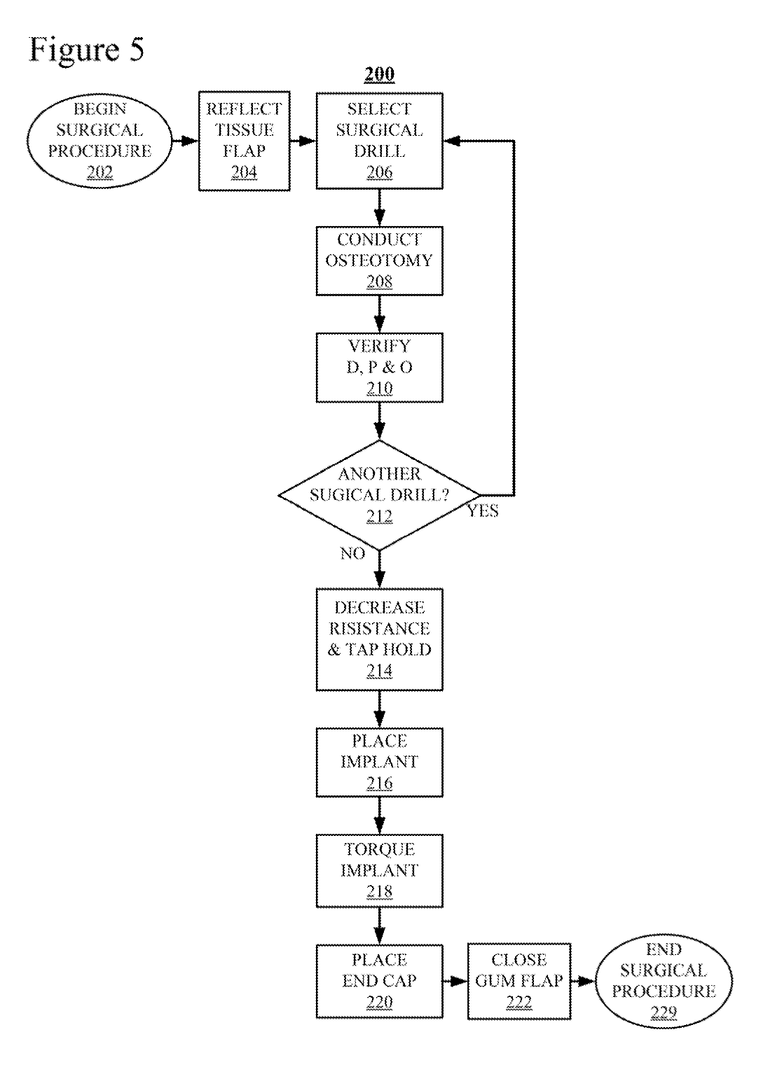

FIG. 4 is an illustration of restorative kit 108, introduced above in conjunction with FIG. 2, of DIDS 110 in greater detail. Restorative kit 108 includes a prosthetic abutment 166, that as described above in conjunction with FIG. 3 is affixed to implant fixture 130 (FIG. 3) once osseos-integration has occurred. A plurality of set screws 168-170 are employed to affix abutment 166 to implant fixture 130. An impression coping 172 is employed to transfer a coping abutment to a lab model for proper analysis. A dental wrench 174 enables prosthetic abutment 166 to be secured to implant fixture 130 with the proper amount of torque. Dental wrench 174 is configured to apply the appropriate torque (see 218 FIG. 5) eliminating any unnecessary pressure that may lead to “stripping” internal threading (not shown) of implant fixture 130, which might compromise the attachment of prosthetic abutment 166 to implant fixture 130. Finally, a standard thumb driver 176 is employed to remove healing cap 134 (FIG. 3) from implant 130 and to place and turn set screws 168-170 that hold prosthetic abutment 166 in place.

Like implant kit 106, each of components 166, 168-170, 172, 174 and 176 is sterilized and fitted into molded indentations 109 (FIG. 1) of tray 100. Like implant kit 106, the upper surface of restorative kit 108 is covered with a material (not shown) that enables components 166, 168-170, 172, 174 and 176 to remain sterile until used. New instruments are used for each patient, which prevents lost or damaged instruments and minimizes turnaround time. In this manner, the claimed subject matter eliminates the need to sterilize restorative kit 106 either before or after surgery, mitigating improper sterilization techniques and the potential of cross contamination between patients.

FIG. 5 is a flowchart of surgical procedure 200 that employs surgical kit 106 (FIGS. 2 and 3) of DIDS 110 (FIG. 2). Procedure 200 starts in a “Begin Surgical Procedure” block 202 and proceeds immediately to a “Reflect Tissue Flap” block 204. During block 204, a dentist reflects a flap of a patient's tissue under adequate local anesthesia to reveal as much of the bone surface necessary to place implant fixture 130 (FIGS. 2 and 3). An irrigated latch lock surgical hand-piece (not shown) may be employed throughout this procedure.

During a “Select Surgical Drill” block 206, the appropriate drill bit 112-116 (FIG. 3) is selected. The first time thorough surgical procedure 200, starter/pilot drill bit 112, which is the smallest diameter drill bit, is typically selected. During a “Conduct Osteotomy” block 208, the drill bit selected during block 206 is employed to either create or enlarge a hole in the bone. During the first pass, starter/pilot drill bit 112 is employed to create a preparation hole in the patient's bone with revolutions per minute (RPMs) typically not exceeding four hundred (400) RPMs. For larger implants fixtures, the maximum RPMs may be reduced to fifty to seventy-five (50-75) RPMs. In addition, the osteotomy site should be drilled to a depth to match the length of implant fixture 130 in accordance with a treatment plan constructed by the dental practitioner.

During a “Verify Depth, Parallelism and Orientation” (D,P & O) block 210, parallel pins 118 and 120 are employed to verify the depth, parallelism and orientation of the hole. This may be accomplished after each new surgical drill bit 112-116 by placing one of parallel pins 118 or 120 into the hold and taking a radiograph if necessary. During an “Another Surgical Drill?” block 212, a determination is made as to whether or not another larger diameter surgical drill bit 113-116, is required. This determination is based upon the depth, parallelism and orientation of the osteotomy site as determined during block 210. If it is determined that another drill bit 113-116 is necessary, the procedure returns to block 206, an appropriate surgical drill bit 113-116 is selected and the procedure proceeds as describe above. During subsequent iterations of block 208, the selected surgical drill bit 113-116 may be used to enlarge the osteotomy site, correcting parallelism and orientation as needed.

If, during block 212, a determination is made that another surgical drill bit 113-116 is not necessary, the dental practitioner then proceeds to a “Decrease Resistance and Tap Hole” block 214. During block 214, surgical drill 122 (FIG. 3) is employed to decrease the resistance of the osteotomy site during placement of implant fixture 130. In a Type 1 dense bone, it may be needed to tap the entire depth of the osteotomy. In a type 2 or 3 bone, it may be necessary to tap the first one half of the bone. Type 4 bone may not require tapping at all. To tap, the drill tap 122 is placed in the irrigated surgical hand-piece (not shown) with the speed typically not set to exceed fifty (50) RPM. Once a desired tap depth has been reached, the direction of the drill tap 122 is reversed and backed out at a speed not to exceed fifty (50) RPM. Drill tap 122 should not be removed from the osteotomy while tap drill 122 is rotating in a forward direction.

During a “Place Implant” block 216, implant driver 136 (FIG. 3) is placed on the surgical hand piece and the speed of the hand piece is adjusted. The speed should typically not exceed fifteen (15) RPM during placement of implant fixture 130. Packaging (not shown) associated with implant fixture 130 is opened and implant fixture 130 is engaged with a carrier (not shown). Care should be taken to not touch the external aspect of implant fixture 130 with anything to maintain a sterile condition. Implant fixture 130 is delivered to and place in the prepared osteotomy, taking care not to over torque implant fixture 130.

If the carrier reaches its torque limit prior to full seating of implant fixture 130, torque wrench 134 (FIG. 3) may be used to complete the procedure during a “Torque Implant” block 218. In other words, torque wrench 134 may be employed to securely seat implant fixture 130 into the drilled and tapped hole at an appropriate torque. Once implant fixture 130 is at a preferred depth, a proper torque of approximately thirty Newtons per Centimeter (30 N-cm) may be achieved by engaging torque wrench 134 for final tightening.

During a “Place End Cap” block 220, end cap 132 (FIG. 3) is placed over implant fixture 130 with one of thumb drivers 142 or 144 (FIG. 3). During a “Close Tissue Flap” block 222, the flap opened in block 204 is closed with an appropriate suture method. Finally, procedure 200 is complete in an “End Surgical Procedure” block 229.

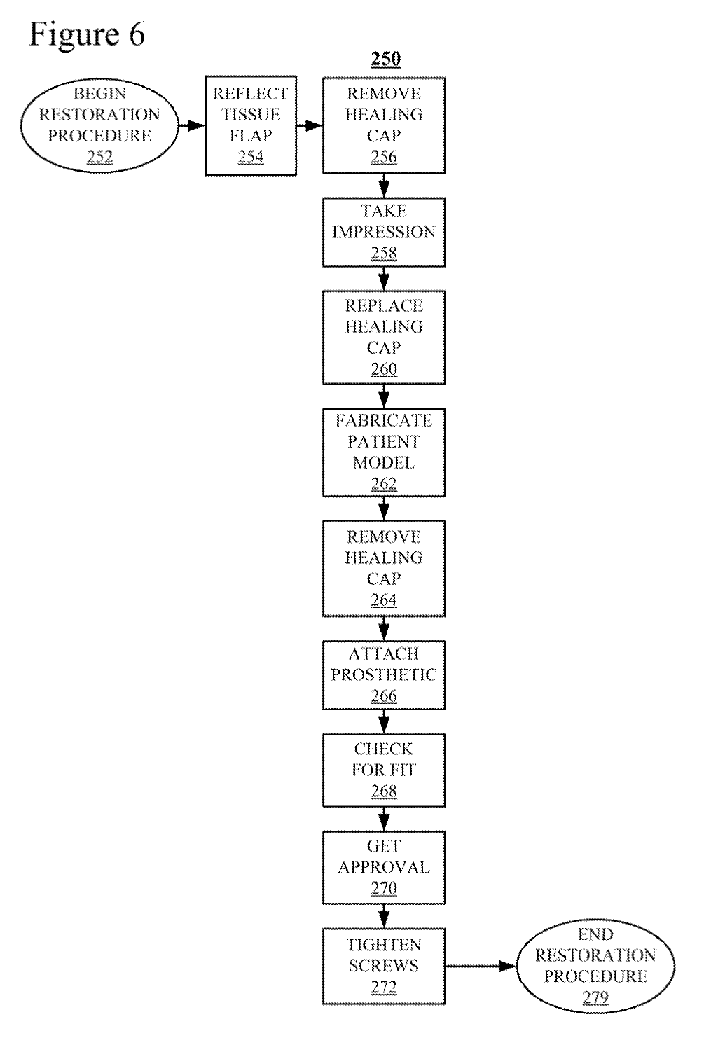

FIG. 6 is a flowchart of Restoration procedure 250 that employs restorative kit 108 (FIGS. 2 and 4) of DIDS 110 (FIG. 2). Procedure 250 starts in a “Begin Restoration Procedure” block 252 and proceed immediately to a “Reflect Tissue Flap” block 254. During block 254, in necessary, a dentist reflects a flap of a patient's tissue under adequate local anesthesia to reveal as much of the bone surface necessary to access implant fixture 130 (FIGS. 2 and 3), which was installed in conjunction with Surgical Procedure 200 (FIG. 5). An irrigated latch lock surgical hand-piece (not shown) may be employed throughout this procedure.

During a “Remove Healing Cap” block 256, thumb driver 176 (FIG. 4) is employed to remove healing cap 134 (FIG. 3) from prosthetic abutment 166 (FIG. 4). It should be understood that although procedure 250 is described with respect to a single tooth, multiple teeth may be processed during a single session. During a “Take Impression” block 258, a patient impression is taken using industry standard impression material in conjunction with either a “closed tray” or “open tray” technique, incorporating all the appropriate impression copings & abutments from Restorative Kit 108 (FIG. 4), executing a “pick up” or “transfer” abutment procedure. It should be noted that for temporary crown and bridge prosthetic attachments (not shown), the appropriate restorative component parts should be used to fabricate and industry acceptable temporary cement should be used to apply and attach the temporary crown and bridge prosthetic attachments.

During a “Replace Healing Cap” block 264, healing cap 134, which was removed during block 256 is replaced to provide temporary protection during additional steps of procedure 250. During a “Fabricate Patient Model” block 262, restorative components are send to a dental laboratory technician for design/fabrication of the patient model. Once the dental model has been fabricated, healing cap 134, which was replaced during block 260, is again removed during a “Remove Healing Cap” block 264. During an “Attach Prosthetic” block 266, the fabricated prosthetic attachment is attached to implant fixture 130.

During a “Check for Fit” block 268, the fabricated prosthetic attachment is checked for fit, proper occlusion and other patient comfort issues. Once fit, occlusion and patient comfort issues have been addressed, approval of the fabricated prosthetic attachment is obtained during a “Get Approval” block 270. During a “Tighten Screws” block 272, one or more attachment screws 168-170 (FIG. 4) are a tightened to proper torque of approximately thirty Newtons per Centimeter (30 N-cm) by engaging torque wrench 174 (FIG. 4). Finally, during an “End Restoration Procedure” block 279, procedure 250 is complete.

While the claimed subject matter has been shown and described with reference to particular embodiments thereof, it will be understood by those skilled in the art that the foregoing and other changes in form and detail may be made therein without departing from the spirit and scope of the claimed subject matter, including but not limited to additional, less or modified elements and/or additional, less or modified procedures performed in the same or a different order.

We claim:

1. An apparatus for performing surgical dental implants, comprising:
a surgical kit comprising:
an implant healing cap;
an implant fixture; and
a first plurality of tools for installing the implant healing cap and the implant fixture;
wherein the implant healing cap, the implant fixture and the first plurality of tools are stored in a sterile condition; and
a restorative kit, comprising:
an implant abutment;
an impression coping;
a locking device; and
a second plurality of tools for installing the implant abutment and the locking device;
wherein the implant abutment, the impression coping, locking device and the second plurality of tools are stored in a sterile condition.

2. The apparatus of claim 1, the first plurality of tools comprising:
a starter drill bit;
a plurality of twist drill bits;
a drill bit extender;
a torque wrench;
a standard wrench;
an implant driver handle;
an implant driver, and
an implant driver extender.

3. The apparatus of claim 1, the second plurality of tools comprising:
a torque wrench;
a standard wrench;
a locking screw driver; and
a locking driver extender.

4. The apparatus of claim 1, the locking device comprising a screw.

5. The apparatus of claim 1, wherein the surgical kit and the restorative kit are coupled with a breakable hinge.

6. A surgical kit, comprising:
a first stage for implanting an implant healing cap and an implant fixture in conjunction with oral surgery; and
a second stage for installing an implant abutment onto the implant fixture, wherein the first stage and the second stage are both packaged in a sterile condition.

7. The surgical kit of claim 6, the first stage comprising:
the implant healing cap;
the implant fixture; and
a first plurality of tools for installing the implant healing cap and the implant fixture.

8. The surgical kit of claim 7, the first plurality of tools comprising:
a starter drill bit;
a plurality of twist drill bits;
a drill bit extender,
a torque wrench;
a standard wrench;
an implant driver handle;
an implant driver; and
an implant driver extender.

9. The surgical kit of claim 6, the second stage comprising:
the implant abutment;
an impression coping;
the locking device; and
a second plurality of tools for installing the implant abutment and the locking device.

10. The surgical kit of claim 9, the second plurality of tools comprising:
a torque wrench;
a standard wrench;
a locking screw driver; and
a locking driver extender.

11. The surgical kit of claim 9, the locking device comprising a screw.

12. The surgical of claim 11, wherein the first stage and the second stage are coupled with a breakable hinge.

13. A method of performing surgical dental implants, comprising:
employing a surgical kit and a restorative kit;
the surgical kit comprising:
an implant healing cap;
an implant fixture; and
a first plurality of tools for installing the implant healing cap and the implant fixture;
wherein the implant healing cap, the implant fixture and the first plurality of tools are stored in a sterile condition; and
the restorative kit, comprising:
an implant abutment;
an impression coping;
a locking device; and
a second plurality of tools for installing the implant abutment and the locking device;
wherein the implant abutment, the impression coping, locking device and the second plurality of tools are stored in a sterile condition.

14. The method of claim 13, the first plurality of tools comprising:
a starter drill bit;
a plurality of twist drill bits;
a drill bit extender;
a torque wrench;
a standard wrench;
an implant driver handle;
an implant driver; and
an implant driver extender.

15. The method of claim 13, the second plurality of tools comprising:
a torque wrench;
a standard wrench;
a locking screw driver; and
a locking driver extender.

16. The method of claim 13, the locking device comprising a screw.

17. The method of claim 13, wherein the surgical kit and the restorative kit are coupled with a breakable hinge.
